(19) United States
(12) Patent Application Publication
(10) Pub. No.: US 2017/0053510 A1
(43) Pub. Date: Feb. 23, 2017

(54) Simple RF Enabled Child Restraint Monitoring Device

(71) Applicant: Robert Louis Lefebvre, Wesley Chapel, FL (US)

(72) Inventor: Robert Louis Lefebvre, Wesley Chapel, FL (US)

(21) Appl. No.: 14/828,236

(22) Filed: Aug. 17, 2015

(51) Int. Cl. G08B 21/02; B60Q 9/00; H04W 4/02; H04L 29/08; H04W 4/00; H04W 4/14

(52) U.S. Cl. CPC G08B 21/0283; H04W 4/005; H04W 4/14; H04W 4/023; H04L 67/20; B60Q 9/00; G08B 21/0261

(57) ABSTRACT

A system and method for monitoring the presence of a child while in a child or infant restraint.

### BACKGROUND B

Some attempted solutions have tried to solve the problem of children and infants being left unattended, but this has not sufficiently addressed the needs of the industry owing to several issues. Many systems were designed around the devices that need to be worn which add extra steps that waste the user's time and increase the chance for error. Also, some devices require a separate detection device for the guardian. For example, forgetting, misplacing, or losing one device makes the system worthless. A lot of children especially younger children and infants do not like wearing anything out of the ordinary which can also be unappealing to both the parent and child. Also, most systems do not incorporate a long distance method for alerts. In another instance the system needs to be integrated into the cars remote as well as doors greatly increasing cost and difficult by requiring all car manufacturers to conform to one remote key and all car seats comply with the same system. Other devices can fail when they require buttons to be pressed for the system to start. For example, many other inventions have a power button which the guardian can forget or incorrectly activate. Temperature sensors used by other systems can lead to false readings because of ambient temperature fluctuations. Additionally, the systems that use temperature sensors to determine ambient temperature are excessive, add complexity and add cost to the system that is not needed. While motion sensors further increase cost and complexity additionally they can give false readings because the child could be sleeping or unconscious. Also utilizes an engine on/off state that further increases the cost and complexity of the system. It would be desirable to provide such system that is substantially simple to fabricate and install. It would also be desirable to provide a system that substantially simplifies operation.

### SUMMARY

Disclosed herein a sensor system providing signal to a predetermined alerting device when a child is buckled into a child restraining device while unattended. This system utilizes a child sensor that can be attached to a compatible restraining device, which allows the guardian to retrofit the system to any restraining device they purchase. The system then activates when the child sensor is connected to the locked position, removing the potential error of improperly turning on the device. The guardian pairs the child sensor and optional cellular transmitter to the guardian's rf compatible device. Once the child monitoring device is activated, if the guardian's rf compatible device exceeds the proximity capable of attending to the child in the restraining device an alert is instantly generated on the guardian's rf compatible device(s). The alert notifies the guardian that the child is still in the restraining device and the guardian has left the proximity capable of attending to the child. In the event the user of the rf compatible device doesn't respond to the first alarm the cellular compatible transmitter will send another alert to a plurality of other persons, authorities, or devices.

In one embodiment the rf compatible device is programmed to send an alert to other contacts that the child has been left behind.

In one embodiment the child restraint may be one of: a) a car seat, b) stroller, c booster seat, d) infant carrier and e) a seat belt.

In a preferred embodiment the rf compatible device is a cellular phone that has capabilities of communicating with and receiving signal from both the child sensor and the cellular transmitter.

### BRIEF DESCRIPTION OF DRAWINGS

Descriptions of the enclosed drawings are as follows:

FIG. 1: is a front view of the sensor clip.

FIG. 2: is a perspective view of a child seat with the child detection devices: A. sensor clip and B. sensor buckle embodiments shown.

FIG. 3: is a perspective view of the obd-II embodiment of the cellular transmitter

FIG. 4: is a perspective view of the 9 volt adapter embodiment of the cellular transmitter

FIG. 5: is a front view of the buckle sensor.

### DETAILED DESCRIPTION OF THE INVENTION

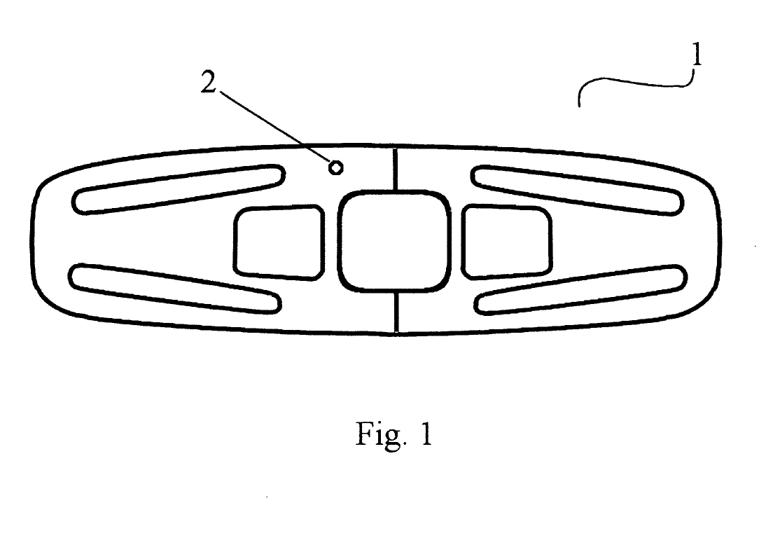

Referring to FIG. 1, a sensor clip 1 that can be secured to a vehicle seat 3 is provided. In one embodiment the sensor clip 1 is equipped with an LED 2 to notify the operator of various statuses including but not limited to: power, signal, battery, and error. In a preferred embodiment the sensor clip 1 is designed to be a replacement for a child seats existing chest clip.

In a preferred embodiment the sensor clip 1 is designed to activate upon locking the clip. Activation could include among other options: depressing a button, or completing a circuit that powers on the device or brings the device out of a lower energy consuming sleep mode. Upon activation a rf connection is established between the sensor clip 1, buckle sensor 4, rf compatible device, and the cellular transmitter. The sensor clip may also be configured to send and receive signals from a plurality of devices. Allowing for multiple guardians to connect to the sensor clip 1 or buckle sensor 4 with their own individual rf compatible device. If the signal is lost between the rf compatible device and either one or both of the sensor clip 1 or buckle sensor 4 an alert is programmed to notify the guardian of the rf compatible device. The guardian may have a programmed amount of time for signal to establish again. Optionally, if the signal isn't established again then the rf compatible device may be programmed to alert a plurality of persons, authorities, or devices that the child has been left alone. The rf compatible device may also be programmed to disable the alarm to avoid unwanted alerts if the child is not alone. For example, a guardian might not have a device or a device capable of creating a connection with the sensor clip 1 or buckle sensor 4. This alert may be among others methods a preprogrammed sms, email, or phone call.

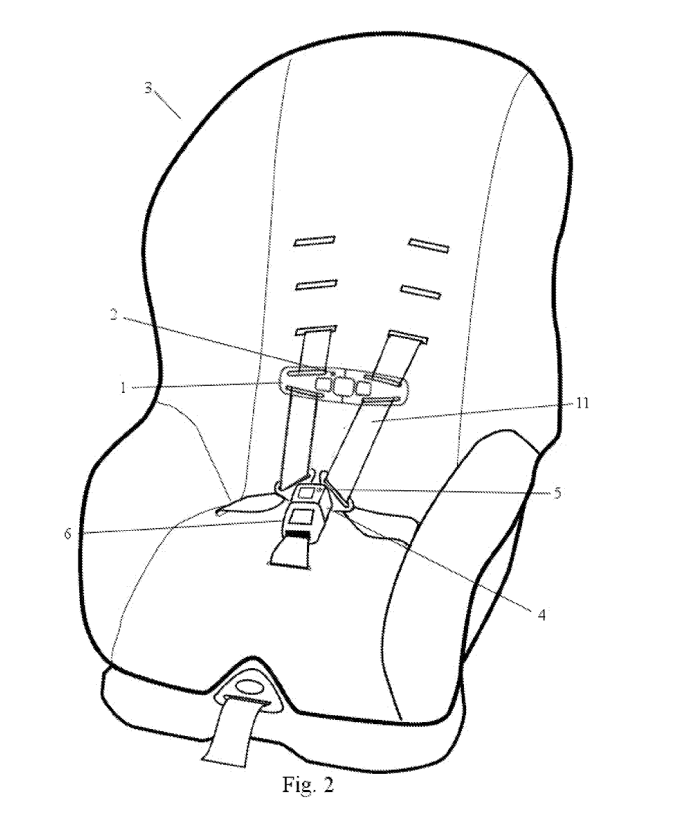

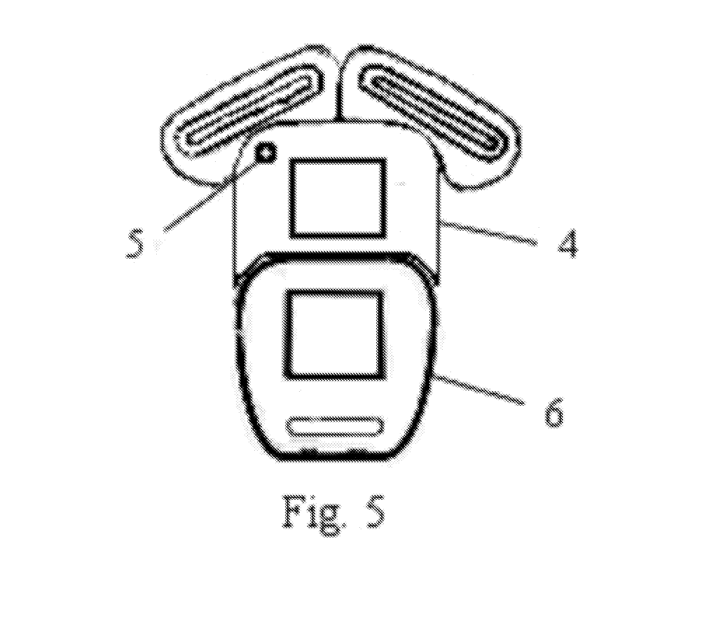

Referring to FIG. 2, a child seat 3 that in a preferred embodiment is equipped with a sensor clip 1 and buckle sensor 4 providing redundancy in the event one device were to malfunction. The buckle sensor 4 also shown in FIG. 5 may be activated by the same methods as the sensor clip. The sensor clip 1 is designed to connect to the child seat 3 harness straps 11. In another embodiment the buckle sensor 4 or sensor clip 1 may be equipped as a standalone child sensor. Alternatively, either child monitoring device 1 and 4 could operate independently of the other device. Utilizing only one device provides a cost saving option. The child monitoring devices 1 and 4 both connect to the rf compatible device. In a preferred embodiment the rf compatible device may be among other things a cellular phone, or tablet. In this preferred embodiment the devices would be capable of communicating with the child monitoring devices using rf as well as the cellular transmitter and a plurality of other persons, authorities, or devices.

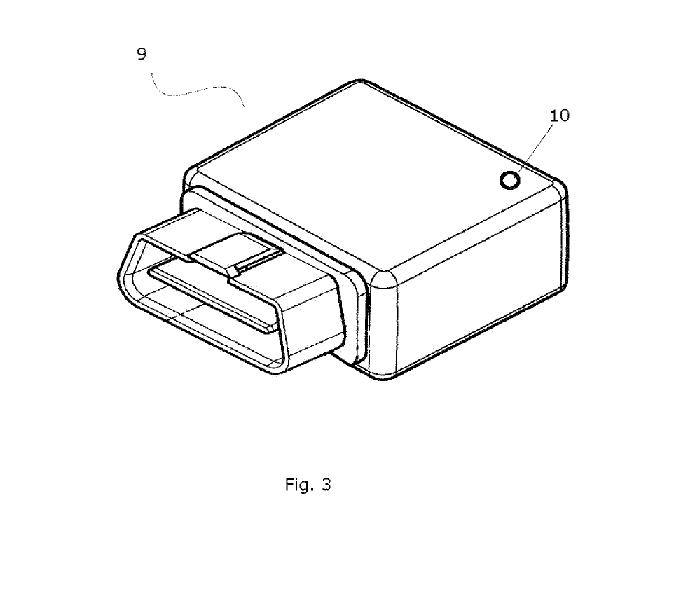

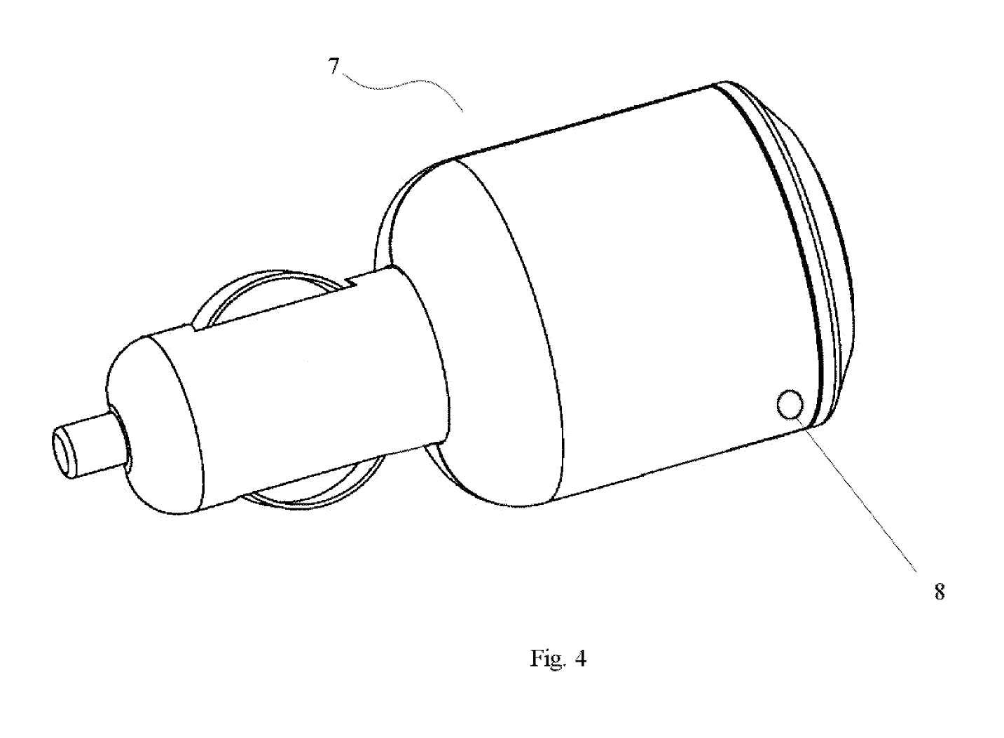

Referring to FIG. 3-4 embodiments for a cellular transmitter are depicted. FIG. 3 is an embodiment where the cellular transmitter is connected to and powered by the vehicles diagnostic port. Alternatively, FIG. 4 is an embodiment in which the cellular transmitter is connected to and powered by the vehicles 9V port. Preferably the cellular transmitter is designed to create redundancy by sending an alert to a plurality of persons, authorities or devices that the child has been left alone. In alternative embodiment the cellular transmitter is integrated into the vehicles electronics or computer. A good example, of this in current technology is OnStar, With the ability to communicate over cellular networks the ability to locate the device using cellular triangulation or forward link are a possibility.

Referring to FIG. 5 a buckle sensor 4 is designed to adapt to a child restraints existing buckle. The buckle sensor 4 may equipped with an LED 2 to notify the operator of various statuses including but not limited to: power, signal, battery, and error.

In another embodiment an ability to modify the distance setting before the alert is activated on the rf compatible device.

In a further embodiment the system includes an ability to modify the time set to reenter the range of the child sensor before a set time elapses and the secondary alert to additional contacts is sent.

In a preferred embodiment the Bluetooth Smart protocol is utilized between the child monitoring device and the rf compatible device. Also, in a preferred embodiment the cellular transmitter also utilizes the Bluetooth Smart or Bluetooth protocol.

1. A child restraining system that will notify guardians of a child left alone comprising:
a) A child restraint;
b) A child sensor associated to the child restraint;
c) A rf compatible device;
d) Cellular transmitter.

2. The system of claim 1 wherein the rf device may be a programmable device such as a cellular phone.

3. The system of claim 1 wherein the child sensor is a sensor clip.

4. The system of claim 1 wherein the child sensor is buckle sensor.

5. The system of claim 1 wherein the child sensor may utilize a LED for signaling active and error statuses.

6. The system of claim 1 wherein the child sensor is activated upon locking, establishing a connection with the rf compatible device and/or the cellular transmitter.

7. The system of claim 1 where in the rf compatible device is capable of being programmed to change optional settings.

8. The system of claim 1 wherein the child sensor communicates using an rf signal to the cellular transmitter.

9. The system of claim 1 in which the cellular transmitter is capable of sending a cellular signal.

10. The system of claim 1 where in the cellular transmitter is compatible with the vehicles OBD-2 port.

11. The system of claim 1 in which the cellular transmitter compatible with the 12V automotive electrical socket.

12. The system of claim 1 in which the cellular transmitter is integrated into the vehicles electronics system.

13. A method comprising:
detecting whether an occupant is present in a child restraint;
creating a link with the rf compatible device and the cellular transmitter;
monitoring the proximity of the rf compatible device and the rf compatible device generating one or more alerts if the proximity exceeds the predetermined range before the child sensor has been deactivated and the the child sensor generating a second alert to the cellular transmitter; and then the cellular transmitter alerting predetermined persons or authorities.

14. The method of claim 13, further comprising determining whether a occupant is present in the restraint when the child sensor is locked.

15. The method of claim 14, in which locking the sensor clip completes an electrical circuit powering on and activating the sensor clip.

16. The method of claim 14, in which locking the sensor clip depresses a button within the clip activating the device.

17. The method of claim 13, further comprising creating a connection with the rf compatible device.

18. The method of claim 13, further comprising creating a connection with the cellular transmitter.

19. The method of claim 13, further comprising monitoring for proximity variations.

20. The method of claim 13, further comprising determining if proximity value exceeds the predetermined range.

21. The method of claim 13, further comprising allowing a set duration for the child sensor and the rf compatible device to reestablish a connection.

22. The method of claim 13, further comprising activation of an alert on the rf compatible device when the device has exceeded the predetermined range.

23. The method of claim 13, further comprising manual deactivation of the alarm on the rf compatible device while still in communication range of the child sensor.

24. The method of claim 23, further comprising the rf compatible device having the capability to send a manual signal to the cellular transmitter to deactivate the alarm if outside the communication range of the child sensor

25. The method of claim 23, further comprising the cellular transmitter forwards the signal to the child sensor to deactivate the alarm.

26. The method of claim 13, further comprising a set time delay before child sensor sends alert to the cellular transmitter.

27. The method of claim 26, further comprising the rf compatible device reentering the proximity prior to expiration of set time delay.

28. The method of claim 26, further comprising the deactivation of the rf compatible device alarm.

29. The method of claim 26, further comprising the reactivation of the child sensor monitoring status.

30. The method of claim 13, further comprising the child sensor signaling the cellular transmitter to the absence of the rf device after set time has elapsed.

31. The method of claim 13, further comprising the cellular transmitter sending one or more sms (Short Message Service) alerts.

32. The method of claim 13, further comprising the cellular transmitter notifying the additional contacts.

33. The method of claim 13, further comprising the cellular transmitter notifying a third party monitoring company.

34. The method of claim 13, further comprising the child sensor alerting the rf compatible device of low battery status.

35. The method of claim 13, further comprising the child sensor alerting the cellular transmitter of low battery.

36. The cellular transmitter illuminating a light emitting diode notification of low battery status of the child sensor.

37. The cellular transmitter notifying the rf compatible device of low battery.

38. The cellular transmitter notifying a third party as to the battery status of the child sensor.
